(19) United States
(12) Patent Application Publication
(10) Pub. No.: US 2018/0350014 A1
(43) Pub. Date: Dec. 6, 2018

(54) TRADEMARK INFORMATION MANAGEMENT SYSTEM AND METHOD

(71) Applicant: NANJING TRADEMARK UBER INTELLECTUAL PROPERTY SERVICE CO., LTD., Jiangsu (CN)

(72) Inventors: Zhongling QIN, Beijing (CN); Wuling QIN, Beijing (CN); Yan XUE, Beijing (CN)

(21) Appl. No.: 15/779,823

(22) PCT Filed: Nov. 30, 2016
(86) PCT No.: PCT/CN2016/107827

§ 371 Date: May 29, 2018

(30) Foreign Application Priority Data
Dec. 1, 2015 (CN) 201510866402.4

(51) Int. Cl. G06Q 50/18; G06Q 30/04; G06Q 30/06; G06Q 30/02; G06Q 30/08

(52) U.S. Cl. CPC G06Q 50/184; G06Q 30/04; G06Q 30/08; G06Q 30/0203; G06Q 30/0613

(57) ABSTRACT

A trademark information management system and method. The system comprises a client (10), an information management server (20), a database (30), a fee payment server (40), and an agent terminal (50). The method comprises the following steps: receiving trademark objection/reexamination request information transmitted by the client, and performing a search of agents; performing screening on the agents and recommending the screened agent to the client; determining the agent and monitoring the case the agent represents; activating a payment guarantee management; and evaluating the agent. The system and method realize a one-stop appointment of agent and application for trademark rejection reexamination/objection, enable an applicant to freely select an agent for a case to have a full understanding of case progress and improve the reliability and work efficiency of rejection reexamination/objection application management.

### I. TECHNICAL FIELD

The present invention relates to the information processing field, particularly to a trademark information management system and a trademark information management method.

### II. BACKGROUND ART

In existing trademark applications for registration, the trademark applicant, review applicant for refused trademark, or trademark opposition applicant usually entrusts an agency to handle the affairs, but has to finish works including seeking for an agency, confirming the agency, and signing an agency agreement, etc., before entrustment. By this way, the trademark applicant, review applicant for refused trademark or trademark opposition applicant has to put into a great deal of manpower and material resources, and the efficiency is very low.

### III. CONTENTS OF THE INVENTION

In order to overcome the drawbacks in the prior art, the present invention provides a trademark information management system and a trademark information management method, with which a refused trademark review application or trademark opposition application can be handled online quickly and efficiently.

In order to attain the object described above, the trademark information management system provided in the present invention comprises clients, an information management server, a database, a fee payment server, and agent terminals, wherein,

the client is configured to receive instructions from a trademark opposition/review applicant, transmit request information of trademark opposition/review case to the information management server, and exchange information with the information management server;

the information management server is configured to receive the trademark opposition/review request information transmitted from the client, perform agent screening, transmit agency information to the agent terminals, control payment of agent fee made by the fee payment server, and monitor case progress;

the database is configured to store agent information, applicant information, and case information;

the fee payment server is configured to accept instructions from the information management server, and carry out fee query and payment;

the agent terminal is configured to accept instructions from the agents, and exchange information with the information management server.

Furthermore, the client transmits information of an agent confirmed by the applicant in proposed agent information to the information management server, and establishes a communication platform with a corresponding agent terminal.

Furthermore, the client receives agent feedback survey information transmitted from the information management server, and transmits agent assessment information to the information management server.

Furthermore, the trademark information management system further comprises third-party assessment terminals configured to carry out third-party assessment for the cases.

Furthermore, the agent terminal queries for applications filed lately according to the rank of the agent, accesses records of the applications, and sets a status flag for the corresponding agent.

Furthermore, the information management server further comprises an applicant registration management module, a trademark review and adjudication request management module, an agent registration management module, a latest trademark application prompting module, an applied trademark query module, a trademark agent query and confirmation module, a trademark agent recommendation module, a bidding module, a payment assurance management module, a deal locking module, a review and adjudication quality monitoring module, and an agent assessment module, wherein,

the applicant registration management module is configured to receive registration information from a client, register the applicant, and set a status flag to represent a rank of the client;

the trademark review and adjudication request management module is configured to receive application information of trademark review and adjudication request from a client, and save the application information in an application data table associated with a client data table;

the agent registration management module is configured to receive registration information from an agent terminal, register the agent, and set a rank flag for the agent;

the latest trademark application prompting module transmits information of agent selected according to rules to the client, to notify the applicant;

the applied trademark query module is configured to receive request from an agent terminal, and search for application records of trademark opposition/review request submitted lately according to the rank of the agent;

the trademark agent query and confirmation module is configured to query for agents in the database for the client to select; confirm the agent selected by the client, and transmit the confirmation information to the client and the agent terminal respectively;

the trademark agent recommendation module is configured to select agents who meet rules as candidate agents and recommend the candidate agents to the client of the applicant;

the bidding module is configured to provide agent rank information, reference agent fee, and the lowest agent fee to the applicant according to a request from the client, so that the applicant can make a choice;

the payment assurance management module is configured to transmit case fee information to the fee payment server according to the status of the application, and receive payment information transmitted from the fee payment server;

the deal locking module is a communication platform between the agent and the applicant for the application being processed;

the review and adjudication quality monitoring module is configured to monitor the application processing flow;

the agent assessment module is configured to transmit feedback survey to the client and the agent terminal, and receive survey results transmitted from the client and the agent terminal.

Furthermore, the information management server further comprises a third-party assessment module, which provides third-party assessment opinion on the case handling according to the third-party assessment information from the third-party assessment terminal.

To attain the object described above, the trademark information management method provided in the present invention comprises the following steps:
1) receiving trademark opposition/review request information transmitted from a client and querying for agents;
2) screening the agents and recommending agents to the client;
3) confirming an agent, and monitoring the case;
4) initiating payment assurance management;
5) assessing the agent.

Furthermore, the method further comprises the following steps before the step 1): setting status flags for registered applicants; setting rank flags for agents; the agent setting his/her own status flag.

Furthermore, the step 1) further comprises the following steps: the information management server parsing the trademark opposition/review request information, generating applicant information, trademark opposition/review case information, and agent condition information; querying in a database according to the agent condition information; transmitting the applicant information and trademark opposition/review case information to agent terminals of queried eligible agents; the agent terminals feeding back case response information to the information management server.

Furthermore, the agent condition information includes agent price, agent rank, occupational service time of the agent, quantity of handled cases, and region of the agent.

Furthermore, the case response information includes whether the case is accepted, case handling time, service price, and possibility of success.

Furthermore, the procedure of screening the agents and recommending agents to the client in the step 2) is: screening out agents who meet the recommendation conditions under the recommendation rules according to the case response information, and recommending the agents to the client; the recommendation rules include: service price (from low to high), agent rank (from high to low), assessment on the feedback information (from high to low), service place of agent (from near to far), and agent workload (from low to high).

Furthermore, the step 3) further comprises the following steps: the client selecting an agent from the recommended agents, and transferring the fee to an account specified by the fee payment server; issuing an entrustment instruction to the corresponding agent terminal; establishing an information exchange platform between the client and the agent terminal.

Furthermore, the step 5) further comprises the following steps: monitoring the case progress; providing third-party assessment on case handling; confirming case handling result information; assessing the agent; transferring the fee to the account of the agent in the agent terminal.

Furthermore, the method further comprises the following step: refunding the fee to the account of the applicant if the fee is incorrect.

With the trademark information management system and method provided in the present invention, a trademark refusal review/trademark opposition applicant can file a trademark refusal review/opposition application, pay the fee, and choose a trademark agent autonomously by the client; for the same case, advices from various parties can be considered; the work of the trademark agent can be assessed after the application is finished; a trademark agent can communicate with the applicant online via a case handling terminal, or refuse the entrustment request raised by the applicant, and arrange work according to his/her time schedule; both the applicant and the agent are not limited by geographical location; a third party may be entrusted to provide assessment and supervision. The system and method provided in the present invention realize one-stop entrustment and application for trademark refusal review/opposition, enable an applicant to choose a case agent autonomously and learn about the case process comprehensively, and thereby improve reliability of refusal review/opposition application management and working efficiency.

Other features axed advantages of the present invention will be illustrated in the following text and partly become apparent from the Description, or will be understood through implementation of the present invention.

### IV. DESCRIPTION OF DRAWINGS

The accompanying drawings are provided for further understanding of the present invention, and constitute a part of the description. These drawings are used in conjunction with the content of the present invention and the examples to interpret the present invention, but don't constitute any limitation to the present invention. In the figures:

FIG. 1 shows the architecture diagram of the trademark information management system according to the present invention;

FIG. 2 is a functional block diagram of the information management server according to the present invention;

FIG. 3 is a flow chart of the trademark information management method according to the present invention.

### V. EMBODIMENTS

Hereunder some preferred examples of the present invention will be described, with reference to the accompanying drawings. It should be understood that the examples described here are only provided to describe and interpret the present invention, but don't constitute any limitation to the present invention.

FIG. 1 shows the architecture diagram of the trademark information management system according to the present invention. As shown in FIG. 1, the trademark information management system provided in the present invention comprises: a plurality of clients 10, an information management server 20, a database 30, a fee payment server 40, and a plurality of agent terminals 50, wherein,

each client 10 transmits applicant registration information to the information management server 20 and obtains applicant ID and password; receives input from the applicant, and transmits trademark opposition/review request information to the information management server 20; receives information of a plurality of agents recommended by the information management server 20, agent feedback survey information, and case handling result information, etc., and transmits confirmed agent information and agent assessment information to the information management server 20; transmits payment information to the fee payment server 40; exchange information with an agent terminal 50 under the control of the information management server 20. In this example, the trademark opposition/review request information respectively comprises: applicant information, case information, and agent condition information.

The client 10 in the present invention registers to the information management server 20 through network, and receives applicant ID and password transmitted from the information management server 20; when the applicant registers via the client 10, the applicant may choose free registration, transmit applicant contact information and professional field information to the information management server 20, become a free client and exchange information with the information management server 20; alternatively, the applicant may choose paid registration via the client 10, transmit applicant contact information, requirements, and professional field information to the information management server 20, become a paying client and exchange information with the information management server 20; then, the information management server 20 will transmit professional information and provide valuable market trend information to the paying client from time to time.

The information management server 20 receives applicant registration information transmitted from the clients 10, carries out classified management for the clients 10, receives agent registration information transmitted from the agent terminals 50, and carries out grading management for the agent terminals 50; receives trademark opposition/review request information transmitted from the clients 10, and saves the request information to application data tables associated with client data tables; the information management server 20 queries in the database 30 according to the applicant's requirements for agent, and transmits case information to the terminals 50 of agents who meet the agent conditions; receives case feedback information transmitted front the agent terminals 50 and provides assessment, and transmits recommended agent information to the client 10 for the applicant to select; confirms an agent and monitors the case progress, and transmits the case handling result to the corresponding client 10; receives agent assessment information made by the applicant front the corresponding client 10, and transmits case closing information to the fee payment server 40; receives a query request from an agent terminal 50, queries for applications filed lately and similar application cases, and feeds back a query result to the agent terminal 50; receives a query request from a client 10, queries for agents, and feeds back a query result to the client 10.

The database 30 is configured to store agent information, client data tables, and application data tables; receive instructions from the information management server 20, and carry out information storage and query.

The fee payment server 40 is configured to receive payment information transmitted from a client 10 and case closing information transmitted front the management server 20 through a transmission network, and pay the fee to an agent terminal 50; refund the fee to the applicant's account as instructed by the information management server 20.

Each agent terminal 50 transmits agent registration information to the information management server 20 and obtains ID and password; exchanges information with the information management server 20 through the transmission network respectively; receives applicant information, case information, and agent entrustment instructions, transmits case progress information and case handling result information to the information management server 20, and queries in the database 30 for new trademark opposition or review request information according to the privilege; exchange information with a client 10 under the control of the information management server 20.

The third-party assessment terminal 60 carries out third-party assessment on case handling as instructed by the information management server 20, and feeds back the third-party assessment to the information management server 20.

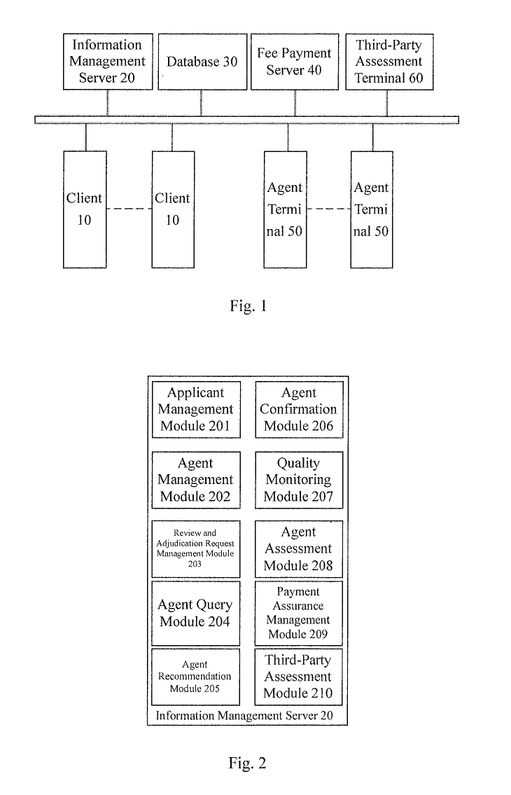

FIG. 2 is a functional block diagram of the information management server according to the present invention. As shown in FIG. 2, the information management server 20 in the present invention comprises an applicant management module 201, an agent management module 202, an agent query module 203, a review and adjudication request management module 204, an agent recommendation module 205, an agent confirmation module 206, a quality monitoring module 207, an agent assessment module 208, a payment assurance management module 209, and a third-party assessment module 210, wherein,

the applicant management module 201 receives registration information from a client 10 and register the applicant, and transmits applicant ID and password to the client 10; carries out classified management for registered clients 10 by class (i.e., ‘junior’ represents free user, and ‘senior’ represents paying user, etc.).

The agent management module 202 receives registration information from an agent terminal 50 and registers the agent, and transmits agent ID and password to the agent terminal 50; carries out grading management for registered agent terminals 50, and sets agent rank flags according to the rule; in this example, the agent rank may be set according to the agent's working years, word of mouth, qualification, and experience, etc. The agent management module 202 receives change information from an agent terminal 50, and changes agent information (e.g., phone number, location, etc.) and agent status flag. An agent may set his/her own status flag according to his business status: “in service” <<->> “suspended”, unless the status flag has been set to “service unavailable”. The default value is “in service”.

The trademark review and adjudication request management module 203 receives trademark review and adjudication request application information from a client 10, saves the application information in an application data table in the database 30 (the application data table is associated with a client data table, to ensure the application information is subordinate to the client information), and transmits recommended agent information to the client 10 for the applicant to select, and receives agent confirmation information from the client 10; provides a communication platform between the agent and the applicant for an application in an application status of “application in progress”.

The agent query module 204 queries in the database 30 according to the agent condition information transmitted from a client 10, and transmits case information to terminals 50 of agents who meet the agent conditions.

The agent recommendation module 205 carries out assessment according to the case feedback information transmitted from the agent terminals 50, transmits information of N recommended agents to the client 10 for the applicant to select according to the rule, and informs all relevant agents and the applicant. In this example, the number of agents recommended each time may be set freely. In this example, the number of agents recommended each time is 5; if the applicant is not satisfied with all of the agents recommended in the first time, the agent recommendation module 205 may recommend a next group of agents to the applicant. The agent recommendation rules may include: service price (from low to high), agent rank (from high to low), feedback information assessment (from high to low), service place of agent (from near to far), and agent workload (from low to high), etc.

The agent confirmation module 206 receives confirmation information transmitted from the client 10, confirms the agent, and transmits the confirmation information to the client 10 and the corresponding agent terminal 50. In this example, the agent confirmation module 206 receives agent response within specified time. The content of the response includes “whether the case is accepted or not”, “possibility of success”, “price”, and “submission time”, etc. If the agent accepts the application, the agent ID will be filled into a “confirmed agent” field in the application record; the status of the application will be set to “payment requested” by the system, and the system informs and cancels all “candidate agents”; the status flag of the application will be set to “agent determined”. If the agent doesn't accept the application or fails to provide response within specified time, the applicant and the agent will be prompted automatically, and the function will be reinitiated.

The review and adjudication quality monitoring module 207 monitors the application handling process, and provides alarm prompt for any application that is overtime, reported, or complained.

The agent assessment module 208 transmits feedback survey to the client 10, and receives an agent assessment result transmitted from the client 10.

The payment assurance management module 209 monitors fee payment status of the applicant and fee payment to the agent for a case being handled.

The third-party assessment module 210 receives third-party assessment information from the third-party assessment terminal 60, and provides third-party assessment opinion on case handling.

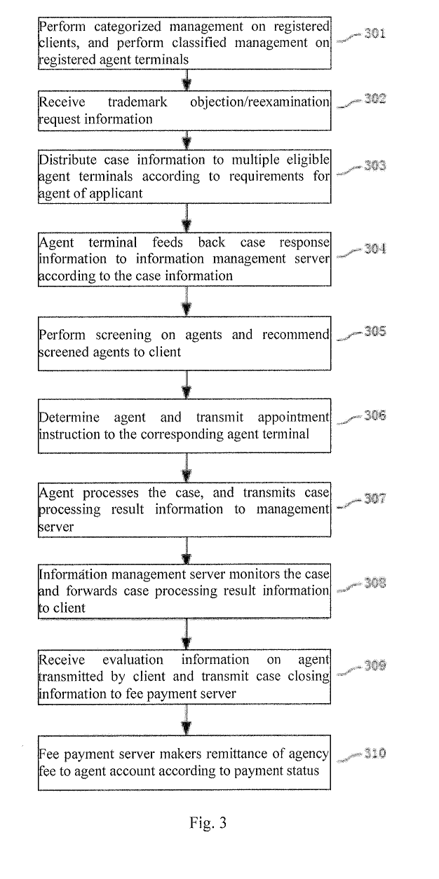

FIG. 3 is a flow chart of the trademark information management method according to the present invention. Hereunder the trademark information management method provided in the present invention will be described in detail with reference to FIG. 3: first, in step 301, each client 10 transmits applicant registration information to the information management server 20, and obtains applicant ID and password; each agent terminal 50 transmits agent registration information to the information management server 20, and obtains ID and password; the information management server 20 carries out classified management for the clients 10 and grading management for the agent terminals 50. In this example, the clients 10 may be classified into junior clients and senior clients, wherein, junior represents free user, and senior represents paying user; the rank of an agent terminal 50 may be set according to the agent's working years, word of mouth, qualification, and experience, etc.

In step 302, a client 10 receives trademark opposition/review case request information inputted by the applicant, and transmits the information to the information management server 20; the trademark opposition/review case request information comprises: applicant information, trademark opposition/review case information, and agent condition information.

In step 303, the information management server 20 receives the trademark opposition/review case request information transmitted from the client 10, and parses the information; the agent query module 204 queries in the database 30 according to the agent condition information in the case request information, and transmits applicant information and case information to terminals 50 of agents who meet the agent conditions.

In the present invention, the agent condition information includes: service price, agent rank, working years of the agent, experience in agency (quantity of handled cases), and region of the agent, etc.

In step 304, each agent who meets the agent conditions receives the above-mentioned applicant information and case information via his/her agent terminal 50, and feeds back case response information (including whether the case is accepted, case handling time, price, and possibility of success) to the information management server 20 via agent terminal 50 according to the applicant information and trademark opposition/review case information.

In step 305, the agent recommendation module 205 screens the agents according to rules and based on a plurality of case response information, recommends the information of N screened agents to the client 10 for the applicant to select, and notify all relevant agents and the applicant. In this example, the number of agents recommended each time may be set freely. In this example, the number of agents recommended each time is 5; if the applicant is not satisfied with all of the agents recommended in the first time, the agent recommendation module 205 may recommend a next group of agents to the applicant. The agent recommendation rules may include: service price (from low to high), agent rank (from high to low), feedback information assessment (from high to low), service place of agent (from near to far), and agent workload (from low to high), etc.

In step 306, the applicant selects an agent from agents who meet the recommendation conditions via the corresponding client 10, and transmits the result of selection to the information management server 20; transfers the fee to an account specified by the fee payment server 40, and sets the application status to “payment requested”; the agent confirmation module 206 confirms the agent according to the result of selection, stores the ID corresponding to the agent in a “determined agent” field in the application record, notifies and cancels all “candidate agents”, and set the application status to “agent confirmed”; the review and adjudication request management module 203 transmits an agent entrustment instruction to the terminal 50 of the agent, establishes an information exchange platform between the client 10 and the confirmed agent terminal for the applicant and the agent to exchange information, and initiates a trademark opposition/review request procedure.

In that step, the payment assurance module 209 monitors the applicant payment situation in the entire process, and notifies the fee payment server 40 for the application in “payment requested” status; the fee payment server 40 mails a bill to the client of the applicant; the fee payment server 40 changes the status of the application for which the fee is received to “application in progress”; after the application is finished (the result may be “successful”, “failed” or “others”), the system changes the status of the application to “paid”; the fee payment server 40 pays the agent fee to the agent, and set the application status flag (e.g., finished—successful).

In the step 307, the agent handles the entrusted trademark opposition/review application, and transmits the progress information to the information management server 20 via the agent terminal 50 from time to time; after the agent task is finished, the agent terminal 50 transmits case handling result information to the review and adjudication request management module 203, and the review and adjudication request management module 203 forwards the case handling result information to the client 10; in that step, if the applicant has any objection to the agent's work or is not satisfied with the case handling result, the applicant may receive third-party assessment information transmitted by the third-party assessment terminal 60 via the third-party assessment module 210, and provides third-party assessment opinion regarding the case handling.

In step 308, the quality monitoring module 207 monitors the progress of the case, and provides alarm prompt for the application that is overtime, reported, or complained in the application handling process.

In step 309, the client 10 receives the case handling result information and feedback survey transmitted from the information management server 20, the applicant confirms the requested case according to the case handling result information and assesses the agent, and transmits case confirmation information and agent assessment result to the information management server 20 via the client 10.

In step 310, the information management server 20 closes the trademark opposition/review request case according to the received case confirmation information, transmits case closing information to the fee payment server 40, and transmits the agent assessment result to the database 30 for storage at the same time; the fee payment server 40 transfers corresponding agent fee to the agent's account or refund the fee to the applicant's account according to the case closing information and fee payment information.

Hereunder the working process of the trademark information management system and method in the present invention will be described in detail in an example “the trademark applicant is informed by the entrusted trademark agency that the applied trademark is refused”.

A trademark applicant logs in the information management server 20 via the client 10, the information management server 20 automatically calculates the time deadline for submission of refusal review application according to the date of issuance from the trademark office inputted on the client 10 or the date of receipt indicated by the stamp, and the content of trademark review and adjudication (trademark refusal review, opposition defense, opposition review, registration rejection review, withdrawal review, invalidation, or invalidation review, etc.), and sends the information to the client 10 of the trademark applicant by means of QQ, SMS, or Wechat, etc. After receiving a prompt for time deadline transmitted from the information management server 20 for the second time, the trademark applicant pays official fee by means of online payment, and thereby obtains a trademark refusal review application form generated by the information management server 20 automatically. After confirming relevant information via the client 10, the trademark applicant selects “Submit by Agency” in an option “please select Submit by Agency or Submit by Myself”. After accepting the instruction from the client 10, the information management server 20 submits the application to the official acceptance center on the most appropriate date calculated automatically by the system, so that the trademark applicant obtains a right of submitting supplementary materials within three months.

Then, the information management server 20 automatically inputs or updates the time deadline for submission of supplementary materials in the system, and notifies the client 10 of this information. In addition, within the time deadline, the information management server 20 transmits prompts and recommended agent information to the client 10 at a preset time interval, till the trademark applicant selects an entrusted agent via the client 10, finishes submission of supplementary materials, or abandons the review. On an Agent Selection page displayed on the client 10, the trademark applicant may select several registered agents according to his/her own requirements (geographical location, experience, quantity of handled cases, quantity of cases being handled, comments, and timeliness, etc.), transmits information related with the case to the agent terminals 50 of the selected agents, and requests the agents to answer several questions for reference (e.g., success ratio, working time required, and agent fee, etc.), and may specify the time for response. After receiving the information via the agent terminals 50, the registered agents may judge whether to accept the entrustment for the case at their own discretion. Agents who intend to accept the entrustment may study the case and answer the questions raised by the trademark applicant on the information management server 20, and the information management server 20 may transmit agent response information or view prompt to the client 10 of the trademark applicant by means of QQ, SMS, or Wechat, etc. After viewing the information, the trademark applicant may select an agent (or agents) or request for another group of agents for screening (as may be set according to the class of the trademark applicant). After the trademark applicant selects an agent and transfers the agent fee indicated by the agent to the account specified by the platform, the information management server 20 notifies the selected agent and requests the agent to confirm the entrustment.

After the agent confirms the entrustment, the mission will appear in a Mission field On the client 10 of the trademark applicant and the agent terminal 50 of the selected agent, and the system will monitor the execution of the mission. The system will send prompts to the agent at several preset time nodes, and may request the agent to upload or update work progress information at those time nodes. If the agent fails to deliver materials to the trademark applicant via the system within a time period set for the mission, the information management server 20 will send prompts to both parties when the time period set for the mission expires. In such a case, the trademark applicant may decide to wait further or sub-entrust other agent. If the agent delivers required materials to the trademark applicant via the system within the time period set for the mission, the information management server 20 will then monitor the feedback time of the client 10; if the system obtains confirmation from the trademark applicant or the set time period expires, the system will transfer the predetermined agent fee to the agent and terminate the mission. Alternatively, the trademark applicant may reply to the agent within the specified time limit, put forward his/her opinions, and request the agent to make amendment and submit the amended materials within a specified time period. In that case, the system will monitor the time again, till the trademark applicant confirms that the application materials are completed via the client 10.

After the trademark applicant confirms that the mission is accomplished, the trademark applicant may select “Submit by Agent” or “Submit by Myself” on the client 10. In addition, the trademark applicant may make assessment on the agent for reference by others.

With the trademark information management system and method provided in the present invention, an applicant of trademark opposition/review application can select a satisfactory agent autonomously according to his requirement, and can receive advices from various parties for the same case.

Those skilled in the art should understand: those described above are only some preferred examples of the present invention, and should not be used to limit the present invention. Though the present invention is described in detail with reference to the examples, those skilled in the art can easily make modifications to the technical scheme described above in the examples or make equivalent replacement for some technical features. Any modification, equivalent replacement, or refinement made to the examples without departing from the spirit and the principle of the present invention shall be deemed as falling into the scope of protection of the present invention.

1. A trademark information management system, comprising clients, an information management server, a database, a fee payment server, and agent terminals, wherein, the client is configured to receive instructions from a trademark opposition/review applicant, transmit request information of trademark opposition/review case to the information management server, and exchange information with the information management server;
the information management server is configured to receive the trademark opposition/review request information transmitted from the client, perform agent screening, transmit agency information to the agent terminals, control payment of agent fee made by the fee payment server, and monitor case progress;
the database is configured to store agent information, applicant information, and case information;
the fee payment server is configured to accept instructions from the information management server, and carry out fee query and payment;
the agent terminal is configured to accept instructions from the agents, and exchange information with the information management server.

2. The trademark information management system according to claim 1, wherein, the client transmits information of an agent confirmed by the applicant in proposed agent information to the information management server, and establishes a communication platform with a corresponding agent terminal.

3. The trademark information management system according to claim 1, wherein, the client receives agent feedback survey information transmitted from the information management server, and transmits agent assessment information to the information management server.

4. The trademark information management system according to claim 1, wherein, the trademark information management system further comprises third-party assessment terminals configured to carry out third-party assessment for the cases.

5. The trademark information management system according to claim 1, wherein, the agent terminal accepts instructions from the agent, queries for applications filed lately, accesses records of the applications, and sets a status flag for the corresponding agent.

6. The trademark information management system according to claim 4, wherein, the information management server further comprises an applicant registration management module, a trademark review and adjudication request management module, an agent registration management module, a latest trademark application prompting module, an applied trademark query module, a trademark agent query and confirmation module, a trademark agent recommendation module, a bidding module, a payment assurance management module, a deal locking module, a review and adjudication quality monitoring module, and an agent assessment module, wherein,
the applicant registration management module is configured to receive registration information from a client, register the applicant, and set a status flag to represent a rank of the client;
the trademark review and adjudication request management module is configured to receive application information of trademark review and adjudication request from a client, and save the application information in an application data table associated with a client data table;
the agent registration management module is configured to receive registration information from an agent terminal, register the agent, and set a rank flag for the agent;
the latest trademark application prompting module transmits information of agent selected according to rules to the client, to notify the applicant;
the applied trademark query module is configured to receive request from an agent terminal, and search for application records of trademark opposition/review request submitted lately according to the rank of the agent;
the trademark agent query and confirmation module is configured to query for agents in the database for the client to select; confirm the agent selected by the client, and transmit the confirmation information to the client and the agent terminal respectively;
the trademark agent recommendation module is configured to select agents who meet rules as candidate agents and recommend the candidate agents to the client of the applicant;
the bidding module is configured to provide agent rank information, reference agent fee, and the lowest agent fee to the applicant according to a request from the client, so that the applicant can make a choice;
the payment assurance management module is configured to transmit case fee information to the fee payment server according to the status of the application, and receive payment information transmitted from the fee payment server;
the deal locking module is a communication platform between the agent and the applicant for the application being processed;
the review and adjudication quality monitoring module is configured to monitor the application processing flow;
the agent assessment module is configured to transmit feedback survey to the client and the agent terminal, and receive survey results transmitted from the client and the agent terminal.

7. The trademark information management system according to claim 6, wherein, the information management server further comprises a third-party assessment module, which provides third-party assessment opinion on the case handling according to the third-party assessment information from the third-party assessment terminal.

8. A trademark information management method, comprising the following steps:
1) receiving trademark opposition/review request information transmitted from a client and querying for agents;
2) screening the agents and recommending agents to the client;
3) confirming an agent, and monitoring the case;
4) initiating payment assurance management;
5) assessing the agent.

9. The trademark information management method according to claim 8, wherein, the method further comprises the following steps before the step 1): setting status flags for registered applicants; setting rank flags for agents; the agent setting his/her own status flag.

10. The trademark information management method according to claim 8, wherein, the step 1) further comprises the following steps: the information management server parsing the trademark opposition/review request information, generating applicant information, trademark opposition/review case information, and agent condition information; querying in a database according to the agent condition information;
transmitting the applicant information and trademark opposition/review case information to agent terminals of queried eligible agents; the agent terminals feeding back case response information to the information management server.

11. The trademark information management method according to claim 10, wherein, the agent condition information includes agent price, agent rank, occupational service time of the agent, quantity of handled cases, and region of the agent.

12. The trademark information management method according to claim 10, wherein, the case response information includes whether the case is accepted, case handling time, service price, and possibility of success.

13. The trademark information management method according to claim 8, wherein, the procedure of screening the agents and recommending agents to the client in the step 2) is: screening out agents who meet the recommendation conditions under the recommendation rules according to the case response information, and recommending the agents to the client; the recommendation rules include: service price (from low to high), agent rank (from high to low), assessment on the feedback information (from high to low), service place of agent (from near to far), and agent workload (from low to high).

14. The trademark information management method according to claim 8, wherein, the step 3) further comprises the following steps: the client selecting an agent from the recommended agents, and transferring the fee to an account specified by the fee payment server; issuing an entrustment instruction to the corresponding agent terminal; establishing an information exchange platform between the client and the agent terminal.

15. The trademark information management method according to claim 8, wherein, the step 5) further comprises the following steps: monitoring the case progress;
providing third-party assessment on case handling; confirming case handling result information; assessing the agent; transferring the fee to the account of the agent in the agent terminal.

16. The trademark information management method according to claim 15, wherein, the method further comprises the following step: refunding the fee to the account of the applicant if the fee is incorrect.
